(19) United States
(12) Patent Application Publication
(10) Pub. No.: US 2005/0237585 A1
(43) Pub. Date: Oct. 27, 2005

(54) Image forming apparatus

(75) Inventors: Yumiko Higashi, Tokyo (JP); Kenji Izumiya, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Konica Minolta Business Technologies, Inc., Tokyo (JP)

(21) Appl. No.: 10/992,018

(22) Filed: Nov. 17, 2004

(30) Foreign Application Priority Data
Apr. 22, 2004 (JP) JP2004-126330

(51) Int. Cl. H04N 1/46

(52) U.S. Cl. 358/500; 358/2.1

(57) ABSTRACT

An image forming apparatus comprising an image forming apparatus for forming an image on paper, based on image data stored in storage means; a color display section for displaying a thumbnail image, based on said image data stored in storage means; a setting section for setting in such a way that a thumbnail image is displayed on said color display section; and control means for controlling the display on said color display unit; wherein said control means is set by said setting section in such a way that a thumbnail image is displayed, and color depth is switched if the color thumbnail image is to be displayed on said color display unit.

### BACKGROUND OF THE INVENTION

1. Technical Field

The present invention relates to an image forming apparatus for forming an image on a sheet of paper by electrophotographic technology.

2. Related Art

An image forming apparatus based on electrophotographic technology such as a digital copying machine has been widely known in the prior art, wherein an latent image is formed by exposition achieved by applying light to the photosensitive layer of a uniformly charged photoconductor, and development is attained by causing toner to be attached to the photosensitive layer with this latent image formed thereon; this being transferred on a sheet of paper whereby an image is formed.

In recent years, the image forming apparatus has been expanding its functions to such an extent that a color image can be formed, and furthermore, an image to be formed can be displayed as a thumbnail image, for example, on an operation screen. Such an apparatus is coming to be disclosed.

For example, in the image forming apparatus described in the Official Gazette of Japanese Patent Tokkai 2003-101797, either the monochrome mode for forming a monochrome image or the color mode for forming a color image can be selected and set when copying a color document. This setting determines whether a monochrome thumbnail image or color thumbnail image should be displayed on the operation screen.

In the prior art image forming apparatus described in the aforementioned Official Gazette of Japanese Patent Tokkai 2003-101797, the following problems have been left unsolved:

According to the image forming apparatus described in the aforementioned Official Gazette of Japanese Patent Tokkai 2003-101797, a color thumbnail image and monochrome thumbnail image can be displayed on the operation screen. As the color depth is increased on the operation screen, the number of colors that can be displayed is also increased. However, this is accompanied by the increased amount of data and longer time is required to get an image displayed. This has raised the problem of poor maneuverability and stress given to the user.

If the color depth is set at a lower level in order to reduce the time of the image being displayed, the number of colors is reduced when the color thumbnail image is displayed, with the result that a coarse image is displayed. Such a conflicting problem has been left unsolved in the prior art.

### SUMMARY OF THE INVENTION

In view of the prior art described above, it is an object of the present invention to provide an image forming apparatus wherein a color thumbnail image is displayed on the operation screen, without the quality of the thumbnail image or maneuverability of other normal operation screens being deteriorated.

The above and other objects and features of the present invention will become apparent from the following detailed description and the appended claims with reference to the accompanying drawings.

### BRIEF DESCRIPTION OF THE DRAWINGS

FIG. 1 is a schematic cross sectional view representing the configuration of one embodiment of the image forming apparatus of the present invention;

FIG. 2 is a block diagram representing configuration related to the control of an image forming apparatus 100 shown in FIG. 1;

FIG. 3 is a drawing representing an example of the flowchart showing the process of initialization, related to the present invention, in the image forming apparatus main body 100 of the present embodiment given in FIG. 1;

FIG. 4 is an example of the flowchart showing the process of changing the contents displayed in the operation/display section 26 of the image forming apparatus main body 100 of the present embodiment given in FIG. 1;

FIG. 5 is a drawing showing an example of the color depth pattern stored in advance in a storage section 24 of the image forming apparatus main body 100 of the present embodiment given in FIG. 1; and

FIG. 6 is another example of the flowchart showing the process of changing the contents displayed in the operation/display section 26 of the image forming apparatus main body 100 of the present embodiment given in FIG. 1, and is different from the example given in FIG. 4.

### DETAILED DESCRIPTION

The following describes the embodiments of the present invention with reference to drawings:

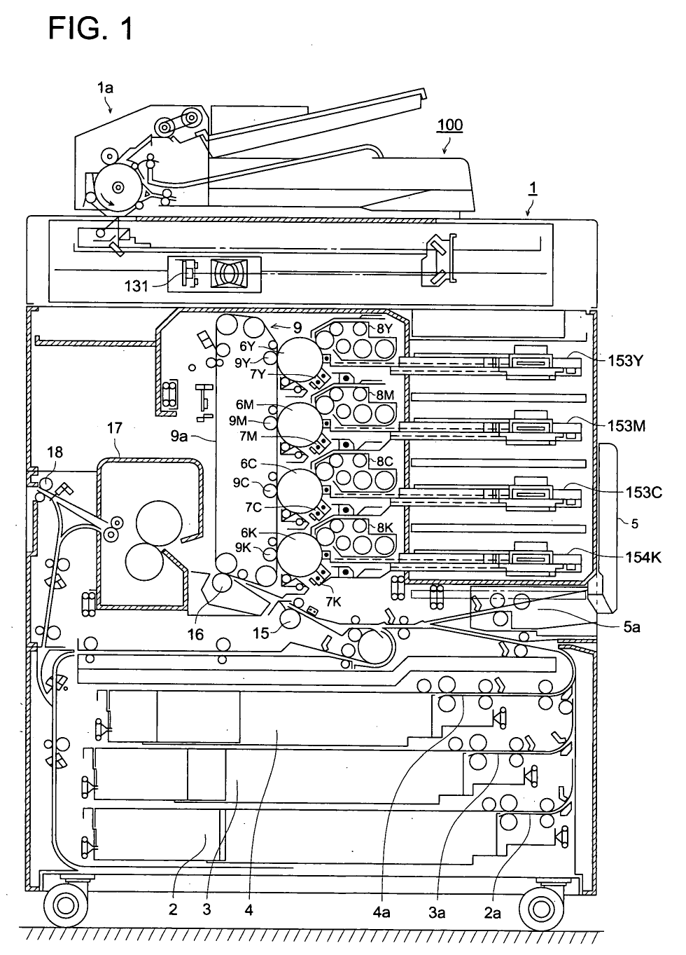

FIG. 1 is a schematic cross sectional view representing the configuration of one embodiment of the image forming apparatus of the present invention. In this embodiment, a copying machine based on electrophotographic technology will be given as an example of the image forming apparatus for the sake of explanation.

Referring to FIG. 1, the configuration and basic operation of the image forming apparatus main body 100 in the present embodiment will be described:

The image forming apparatus main body 100 is provided with multiple sets of document writing units 153Y, 153M and 153C for the color image forming sections, and a document writing unit 154K for the monochrome image forming sections. The document writing unit 153Y permits yellow image formation, the document writing unit 153M magenta image formation, document writing unit 153C cyan image formation, and document writing unit 154K black image formations.

Photoconductors 6Y, 6M, 6C and 6K, charging sections 7Y, 7M, 7C and 7K, and developing sections 8Y, 8M, 8C and 8K are provided in response to the aforementioned document writing units 153Y, 153M, 153C and 154K. Further, an intermediate transfer unit common to the aforementioned color image forming sections and monochrome image forming sections is also provided. The intermediate unit 9 comprises:
an endless belt-shaped intermediate transfer device 9a, wound on the multiple rollers, supported rotatably and arranged in such a way as to contact the aforementioned photoconductors 6Y, 6M, 6C and 6K; and
primary transfer sections 9Y, 9M, 9C and 9K that contact the aforementioned intermediate transfer device 9a to the aforementioned photoconductors 6Y, 6M, 6C and 6K, thereby rotating the image.

The following describes the other configurations. A document reading unit 1 serving as a scanner is mounted on the top of the image forming apparatus main body 100. A document is placed on the glass surface platen and is scanned and read by the document reading unit 1. A CCD 131 where the reflected light obtained by the aforementioned scanning is inputted is arranged in the document reading unit 1. It is preferred that the document reading unit 1 is connected with an ADF (Automatic Document Feed Apparatus) 1a so that both sides of the document can be read.

Further, sheet feed trays 2, 3 and 4 are arranged on the bottom of the image forming apparatus main body 100, and are each provided with sheet feed means 2a, 3a and 4a. Further, a manual feed tray 5 is arranged on the outer wall of the side of the image forming apparatus main body 100, and the sheet feed means 5a for the manual feed tray 5 is provided. Since multiple sheet feed trays and sheet feed means are provided as described above, multiple types of sheets with different sizes can be used.

A registration roller 15 is provided on the leading edge of the sheet feed means 2a through 5a on the sheet feed side. A secondary transfer roller 16 for pressing the sheet on the intermediate transfer device 9a is provided on the further side thereof. A fixing section 17 is provided on the further side of the secondary transfer roller 16. An ejection roller 18 is provided on the further side of the fixing section 17.

In the image forming apparatus main body 100, the image formed as required by the aforementioned document writing units 153Y, 153M, 153C and 154K is transferred onto the intermediate transfer device 9a by the photoconductors 6Y, 6M, 6C and 6K, charging sections 7Y, 7M, 7C and 7K, developing sections 8Y, 8M, 8C and 8K and primary transfer sections 9Y, 9M, 9C and 9K, according to the image forming instruction in color printing. In the monochrome printing, the image formed by the document writing unit 154K is transferred onto the intermediate transfer device 9a by the photoconductor 6K, charging section 7K, developing section 8K and primary transfer section 9K.

In the meantime, the sheet required for image formation is fed by the sheet feed means 2a, 3a, 4a or 5a from either the sheet feed trays 2, 3 and 4 or manual feed tray 5 according to paper size. It is fed to the secondary transfer roller 16 through the registration roller 15. The sheet is pressed against the intermediate transfer device 9a by the secondary transfer roller 16 and the image on the intermediate transfer device 9a is transferred to the sheet. The sheet where the image is transferred is fixed with the image by the fixing section 17 and is ejected outside the image forming apparatus main body 100 through the ejection roller 18.

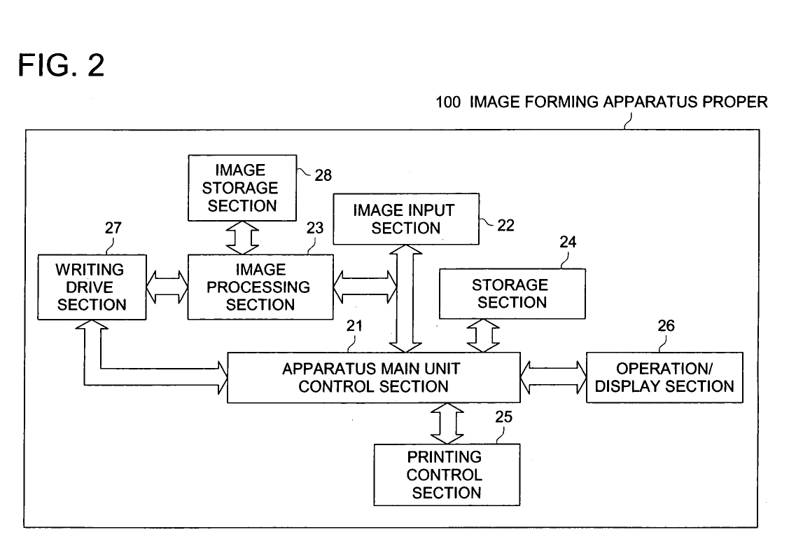

FIG. 2 is a block diagram representing configuration related to the control of an image forming apparatus 100 shown in FIG. 1.

As shown in FIG. 2, the image forming apparatus main body 100 comprises:
an apparatus main unit control section 21 for overall control of the main unit of the apparatus;
an image input section 22 for reading an image from the document by means of a document reading unit 1;
an image processing section 23 which converts RGB data of an read image into image YMCK data and carries out image processing such as tone correction, color correction, screen correction, image magnification change, rotation, an overlay, image compression storage and a reading and extending process of a stored image;
an image storage section 28 for storing image compressed data read by the image input section 22;
a writing drive section 27 for forming a latent image of image process data of YMCK processed by the image processing section 22 on photoconductors for respective colors in the image forming system;
a printer control section 25 which controls the printing operation, for example, by carrying out toner development of a latent image formed on the photoconductor and forming an image on an image forming sheet such as paper;
an operation/display section 26 for displaying information to a user from the image forming apparatus main body 100 and for allowing a user to operate and instruct the image forming apparatus main body 100; and
a storage section 24 for storing thumbnail image data to be displayed in a thumbnail form according to an instruction from the operation/display section 26, software program to be run by the apparatus main unit control section 21 and parameters required for the operation of the image forming apparatus main body 100.

The software program stored in the storage section 24 to be run by the apparatus main unit control section 21 contains the software program for setting and changing the color depth of the present embodiment to be described later. Further, the storage section 24 has a table showing the type of color for each color depth to be described later.

The operation/display section 26 contains a touch panel type operation panel and a fixed button type operation section. The operation/display section 26 should be mounted on the upper stage of the image forming apparatus main body 100, where it can be easily employed by the user, although this is not illustrated in FIG. 1. Further, the operation/display section 26 may contain a display panel section such as a CRT, liquid crystal display and EL, and an input device such as a touch panel and mouse for detecting the coordinate position corresponding to the button position of the display panel.

In the present embodiment, an operation screen for guiding the user for operations under the control of the software program operated by the apparatus main unit control section 21 and the thumbnail image as the thumbnail of the image to be formed are displayed on the operation panel of the operation/display section 26. Further, the display panel section of the operation panel is composed of the LCD and the display is set by the LCD controller in the operation/display section 26.

To be more specific, in the present embodiment, the operation panel display panel section represents an example of the color display section for displaying the thumbnail image based on the image data. It also represents an example of the setting section for setting in such a way that the LCD controller displays the thumbnail image on the color display section. It further shows an example of control means wherein the apparatus main unit control section 21 for operating the software program controls the display on the color display section.

The following provides a detailed description of the operations in the present embodiment.

The image forming apparatus main body 100 as the present embodiment is capable of changing the color depth to be displayed, in response to the contents displayed on the operation/display section 26. For example, the pattern of each of multiple types of the color depths stored in the storage section 24 in advance is scanned by the apparatus main unit control section 21, and this pattern is used to change the color depths when displayed n the operation/display section 26.

In this case, the color depth for displaying the color thumbnail image is set at a higher level than the color depth when an image other than color thumbnail image is displayed, without the present invention being restricted thereto. It is also possible to arrange such a configuration that color depths are changed in multiple steps in response to the contents displayed on the operation/display section 26.

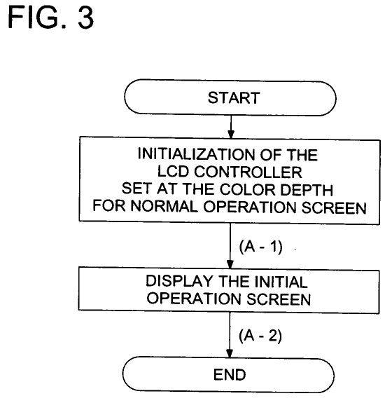

FIG. 3 is a drawing representing an example of the flowchart showing the process of initialization, related to the present invention, in the image forming apparatus main body 100 of the present embodiment given in FIG. 1.

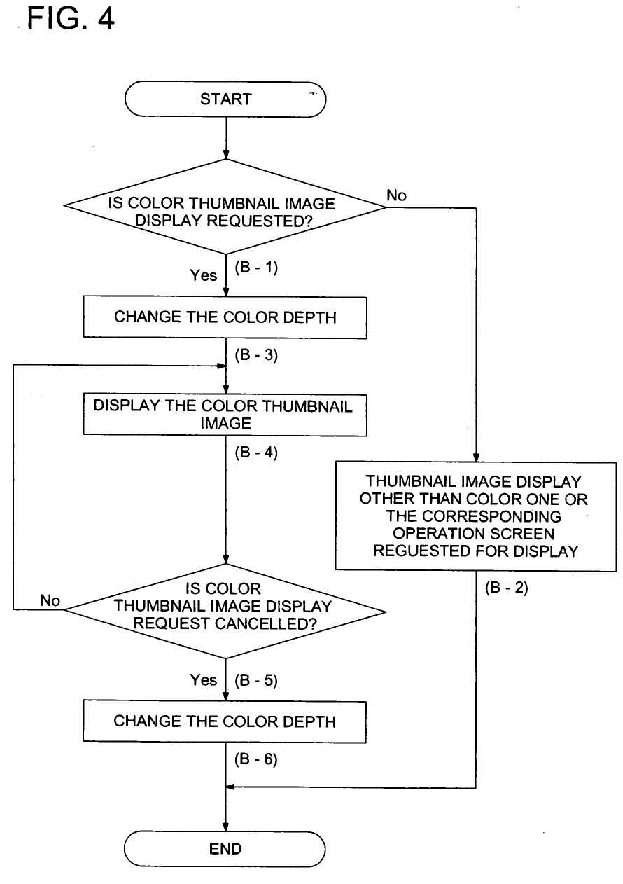

FIG. 4 is an example of the flowchart showing the process of changing the contents displayed in the operation/display section 26 of the image forming apparatus main body 100 of the present embodiment given in FIG. 1.

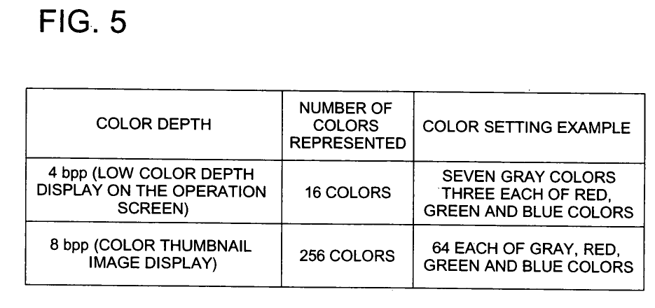

FIG. 5 is a drawing showing an example of the color depth pattern stored in advance in a storage section 24 of the image forming apparatus main body 100 of the present embodiment given in FIG. 1.

Referring to FIG. 3, when the power of the image forming apparatus main body 100 is turned on or is reset (e.g. including the case where resetting is made at the time of recovery of power save mode), the apparatus main unit control section 21 performs initialization of the LCD controller of the operation/display section 26 (A-1). In this initialization, the color depth at the time of displaying on the operation/display section 26 is set to that for the normal operation screen. This setting is made in such a way that the apparatus main unit control section 21 scans the pattern of the color depth as shown in FIG. 5 from the storage section 24, and this pattern is used for displaying on the operation/display section 26.

In this embodiment, “color depth for low color depth display on the operation screen” shown in FIG. 5 is used as the color depth for normal operation screen. This color depth corresponds to 4 bpp (bit per pixel) as shown in FIG. 5. This color depth allows 16 colors to be displayed. To put it more specifically, these 16 colors consist of 7 gray colors, 3 red colors, 3 green colors and 3 blue colors.

In step (A-2), display on the operation/display section 26 is carried out at the color depth set in step (A-1).

The following description will be given with reference to FIG. 4. When changing the contents to be displayed on the operation/display section 26 of the image forming apparatus main body 100, the color depth conforming to the contents to be displayed is used.

In the step (B-1) of FIG. 4, a check is made to see whether or not the contents to be displayed represent a color thumbnail image.

In the step (B-1) of FIG. 4, if the display this time does not represent the color thumbnail image, the color depth remains unchanged and a thumbnail image display other than color one or the corresponding operation screen requested for display is displayed on the operation/display section 26. Then the step (B-2) terminates.

In the meantime, in the step (B-1), if the display this time represents the color thumbnail image, the setting of the color depth when displayed on the operation/display section 26 is changed to that of the color depth for color thumbnail image (B-3). This setting is made in such a way that the apparatus main unit control section 21 scans the pattern of the color depth as shown in FIG. 5 from the storage section 24, and this pattern is used for displaying on the operation/display section 26.

In this embodiment, “color depth for at the time of color thumbnail image depth” shown in FIG. 5 is used as the color depth for color thumbnail image. This color depth corresponds to 8 bpp (bit per pixel) as shown in FIG. 5. This color depth allows 256 colors to be displayed. To put it more specifically, these 256 colors consist of 64 gray colors, 64 red colors, 64 green colors and 64 blue colors.

In the step (B-4), a color thumbnail image is displayed on the operation/display section 26 at the color depth set in step (B-3).

When the color thumbnail image display request has been cancelled (B-5), the setting of the color depth for display on the operation/display section 26 is changed to that of the color depth for normal operation screen (B-6). Then the processing terminates.

As shown above, in the present embodiment, when the color thumbnail image is displayed by the operation/display section 26, the color depth for display is set to a higher level. This arrangement allows a finer image to be displayed at a higher color depth when a thumbnail image is displayed. When an image other than thumbnail image is displayed, usability for the user is improved since a quick switching to the display at a lower color depth is provided.

The following describes another embodiment of the present invention.

In the aforementioned embodiment, the color depth can be set in response only to the contents to be displayed on the operation/display section 26. In the present embodiment, color depth can be changed, in response to the condition of the mode set by the user, for example, in addition to the condition of contents to be displayed.

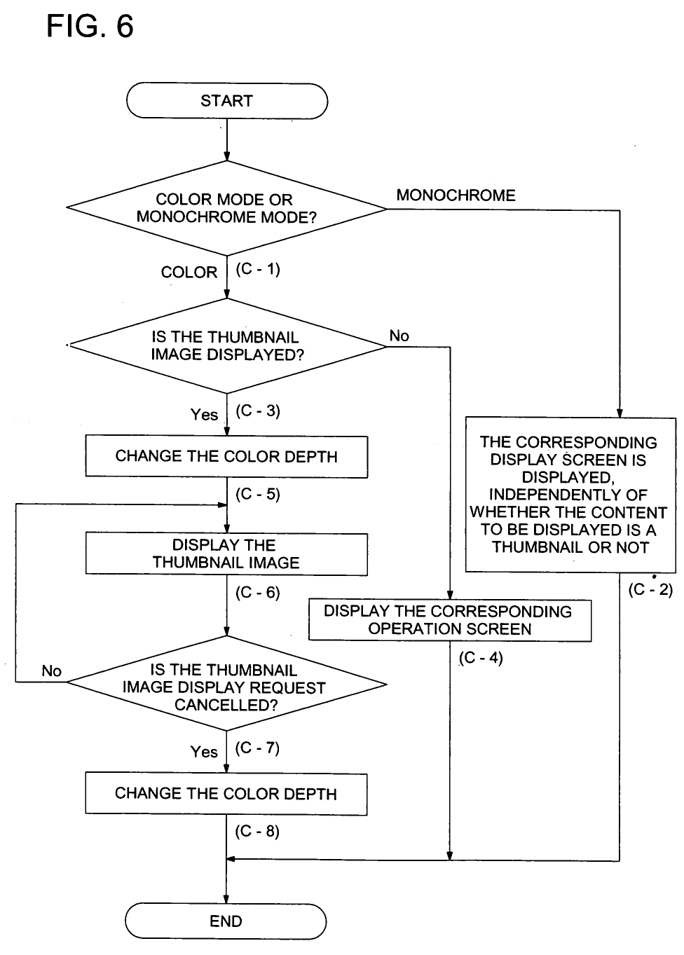

FIG. 6 is another example of the flowchart showing the process of changing the contents displayed in the operation/display section 26 of the image forming apparatus main body 100 of the present embodiment given in FIG. 1, and is different from the example given in FIG. 4.

In step (C-1) of FIG. 6, the current mode is checked. In this example, the image forming apparatus main body 100 is configured in such a way that the user can select either the monochrome mode for forming a monochrome image or the color mode for forming a color image. This mode selection is inputted by the user operation using the operation/display section 26 and, in response to this input, the apparatus main unit control section 21 provides the operation control according to the inputted mode.

When the monochrome mode is selected in the step (C-1) of FIG. 6, the corresponding display screen, requested to be displayed with the color depth kept unchanged, is displayed on the operation/display section 26, independently of whether the content to be displayed thereafter is thumbnail or other than thumbnail (for example, operation display or job list display) (C-2). Then the processing terminates.

When the color mode is selected in the step (C-1), a check is made to see whether the content to be displayed thereafter is thumbnail or not (C-3).

In step (C-3), if the display this time does not show the thumbnail image, the corresponding operation screen, requested to be displayed with the color depth kept unchanged, is displayed on the operation/display section 26, and the (C-3) terminates (C-4).

In step (C-3), if the display this time shows the thumbnail image, the setting of the color depth to be displayed on the operation/display section 26 is changed to that of the color depth for the color thumbnail image (C-5). This setting is made in such a way that the apparatus main unit control section 21 scans the pattern of the color depth as shown in FIG. 5 from the storage section 24, and this pattern is used for displaying on the operation/display section 26.

In the step (C-6), a thumbnail image is displayed on the operation/display section 26 at the color depth set in step (C-5).

When the color thumbnail image display request has been cancelled (C-7), the setting of the color depth for display on the operation/display section 26 is changed to that of the color depth for normal operation screen (C-8). Then the processing terminates.

The present invention is not limited to the foregoing embodiments but many modifications and variations are possible within the spirit and scope of the appended claims of the invention.

An algorithm may be used, wherein when a thumbnail image is selected at C-3 in FIG. 6, a check is made to see whether it is a color thumbnail or a thumbnail other than color one and the color depth of the display is changed based on the check results, although it is not shown in the figure.

1. An image forming apparatus comprising:
an image forming apparatus for forming an image on paper, based on image data stored in storage means;
a color display section for displaying a thumbnail image, based on said image data stored in storage means;
a setting section for setting in such a way that a thumbnail image is displayed on said color display section; and
control means for controlling the display on said color display unit;
wherein said control means is set by said setting section in such a way that a thumbnail image is displayed, and color depth is switched if the color thumbnail image is to be displayed on said color display unit.

2. An apparatus according to claim 1, wherein said color depth is switched over to the color depth where there are a greater number of colors.

3. An image forming apparatus comprising:
an image forming apparatus for forming an image on paper, based on image data stored in storage means;
a color display section for displaying a thumbnail image, based on said image data stored in storage means;
a setting section for setting in such a way that a thumbnail image is displayed on said color display section; and
control means for controlling the display on said color display unit;
wherein said control means is set in such a way that a thumbnail image is displayed on said setting section, and a color thumbnail image is displayed at a color depth different from that when an image other than a color thumbnail image is displayed.

4. An apparatus according to claim 3, wherein the color depth for displaying said color thumbnail is the one having a greater number of colors, as compared to the case where an image other than said color thumbnail image is displayed.

5. An image forming apparatus comprising:
an image forming apparatus for forming an image on paper, based on image data stored in storage means;
a selection section for selecting either a color image formation mode for forming a color image by means of said image forming section or a monochrome image formation mode for forming an monochrome image by means of said image forming section;
a color display section for displaying a thumbnail image, based on said image data stored in storage means;
a setting section for setting in such a way that a thumbnail image is displayed on said color display section; and
control means for controlling the display on said color display unit;
wherein, when said color image formation mode is selected and said control means is set by said setting section in such a way that a thumbnail image is displayed, color depth is switched so that the color thumbnail image is displayed on said color display unit.

6. An apparatus according to claim 5, wherein said color depth is switched to the one having a greater number of colors.
